(19) United States
(12) Patent Application Publication
(10) Pub. No.: US 2008/0010163 A1
(43) Pub. Date: Jan. 10, 2008

(54) System and method providing customers with improved service using a customer telephony device connected to a preference database by an IP Network

(76) Inventor: William Elmer Kish, Moraga, CA (US)

Correspondence Address: William E. Kish, 1738 ST. Andrews Dr., Moraga, CA, 94556, US

(21) Appl. No.: 11/483,372

(22) Filed: Jul. 10, 2006

(51) Int. Cl. G06Q 30/00

(52) U.S. Cl. 705/26

(57) ABSTRACT

The present invention reduces labor cost, reduces shrinkage and reduces stress. It improves customer retention, loyalty and saves time for customers. It is a system where the customer using a telephony device having access to his or her preference database. Where the user can order and the order fulfillment is accurate. This invention eliminates all or part of the need for a customer representative taking phone orders. The system and method provides employee incentive where the employee is assigned to a customer where the customer is notified of new items which can be added to the customer preferences. This provides more opportunity and convenience for the customer.

### FIELD OF TECHNOLOGY

The present invention consists of a system and method for ordering customer preferences from a cellular phone or a telephone having a Caller ID. The customer is provided with a system where the customer can order his or her preferences without the assistance of a order-taker employee. This invention reduces labor cost and mistakes. It provides the customer with no telephone wait times, improves customer satisfaction that the order has been taken correctly. The cellular phone is used frequently today when placing food orders. This invention reduces the sponsored company labor cost, reduces product shrinkage and improves customer loyalty.

### BACKGROUND OF THE INVENTION

Demographics changes are impacting the food service industry. More customers from two-income households demand curbside takeout products because of time constraints, and single parent families have fewer opportunities to grocery shop, and prepare meals. The growing niche of home meal replacement (HMR) is an affordable, attractive option for a growing number of households. Many families regularly eat out two or three times a week, and often even more times a week. Wholesale food businesses remain with using phones to place orders too and many do not use a network computer to order supplies.

Consumers are conditioned now with automatic call centers where they can be prompted and satisfactory fulfilled. The telephone, computer, financial and utility industries have met customer needs of customer inquires, questions and payments prompting individually to a voice response call center where they execute options. With the present invention, choosing preferences prior to ordering can reduce wait times, the customer can enter preferences from a data entry kiosk, personal computer or an employee filing their order while they wait for their order to be fulfilled.

The food service industry includes small to public companies in fast food chains, local pizza chains, cafes, quick-casual (Mexican, chicken, Chinese) operators, supermarket deli, and full service restaurants are markets for the present invention. The restaurant industry provides entry-level jobs as dishwashers, hostesses and busboys. Many employers don't budget the training for English classes and communications between customer and employee are sometimes ineffective leading to problems when taking the order. Many times customer cannot communicate well with employees effectively. The system provides the customer choice of entering his or her order alone and the satisfaction the order will be fulfilled correctly.

### DEFINITIONS

The term “under the control of software components” as used to receive, send, direct, and route and not limited to voice, text, data, files, results, update, record, and storage of the data in the server, appliance, database or any type of computer system.

The term “assess number” as used herein, is a telephone number used by the customer to access the system and to enter the preference database. Dial Number Identification System (DNIS) routes the call to the appropriate agent or auto attendant.

The term “assess number reply,” as used herein is the confirmation the customer has registered his or her preferences and sending the customer the access number confirms the event.

The term “assess number instructions’ as used herein is the instructions from the sponsored company in voice or text on storing the access number on a cell phone. The instructions can be letters, numbers, *, #, or other phone notations or combination of letters, numbers, and notations.

The term “assess number stored,’ as used herein is the customer using his cell phone and storing the assess number within the cell phone or creating a contact name.

The term “customer or consumer,” as used herein, is a user who has registered his or her telephone which is cellular, digital or analog phone. The consumer has given permission to a representative to enter his or her preference or the consumer has entered the preference on a personal computer, a telephone, or a cellular phone.

The term “order” is the customer fulfillment event, and in the restaurant business, the order is a food and beverage transaction event.

The term “location” as used herein is a retail fulfillment center which serves a product which the product is delivered and ordering the product takes a certain amount of time.

The term “PBX” as used herein is a private branch exchange owned by a sponsored company as opposed to one owned by a telephone company.

The term “Point of Sale”, as used herein is an area used to sell goods or services and it can be a virtual location.

The term “preference,” as used herein is the customer list of products or groups of products. Customers may even become merchants, ordering products and supplies.

The term “Preference Database,” as used herein is a selection of customers fulfillment locations and fulfillment products in each location.

The term “Available Product List” as used herein is a list of sponsored company products and said items are available for customer preferences.

The term “Sponsor Company,” as used herein, encompasses any company that wishes to offer the system and method to its customers. A sponsored company is a hosting company, an application service provider, distributor, manufacturer or a company offering product produced or distributed using the present invention. The food service industry is a primary user of this system since product is produced and fulfilled using a telephone.

The term “Voice over Internet Protocol” as used herein, is the routing of voice conversations over the Internet through any IP based network. The protocols used to carry voice signals over the IP Network are referred to as VOIP.

The term “Web server,” as used herein, encompasses any data processing system on which application programs and Internet sites may be stored for access and processing by computers. The Web server employs a customer relationship management application, control manager, web browser that allows for multimedia presentation of information, text, images, sound and video streaming.

### DETAIL DESCRIPTION OF THE DRAWINGS

FIG. 1 is a schematic block diagram of the Host.

FIG. 2 is a schematic block diagram of customer using a cell phone and connecting to the host.

FIG. 3 is a schematic block diagram of a customer order and an employee using a point of sale terminal.

FIG. 4. is a schematic block diagram of a customer locating a fulfillment location and identifying his or her preferences.

### SUMMARY OF THE INVENTION

The present invention produces a cost saving and is an efficient alternative from traditional ordering food and beverage. The food service industry is competitive, and there are many choices for the HMR market. The present invention produces a convenience by using a telephony device for ordering. Cell phones have become critical communication devices where customers can order, place reservation quickly. The invention produces greater convenience for customers where customers choose their preferences and can order with a few actions. The food industry receives a great number of orders during lunch and dinner and longer periods of time are common for customers when taking orders. And commuting customers are concerned about reducing stress and order efficiency.

Commuters have stress and the present invention can reduce cell phone charges, and customer ordering time during the commute. Work shift stress is considered a major cause of lower productivity and many workers are knowledgeable of stress results and therefore stress reduction is critical for well-being.

The present invention reduces labor cost and reduces shrinkage, food and product cost or mistakes. Poor communication skills of food service employees and poor communication skills of customers can lead to greater shrinkage and lower profits. The present invention eliminates any mistake in communications.

The system is hosted in one location and uses the IP network to communicate with customer and with fulfillment locations. It reduces the capital outlay of independent systems for each location and therefore the present invention becomes affordable. Using the IP network, the fulfillment location can export and import data through a host providing the system and methods to the food service industry where companies can offer the service.

The present invention uses a telephone switch system and a Web server to provide the customer preferences with fulfillment.

### DETAIL DESCRIPTION OF THE PREFERRED EMBODIMENT

In this section, the present invention is described in detail with regard to the drawing described in Detail Description of the Drawings. Terms used throughout the remainder of this section are used with the meanings under Definitions.

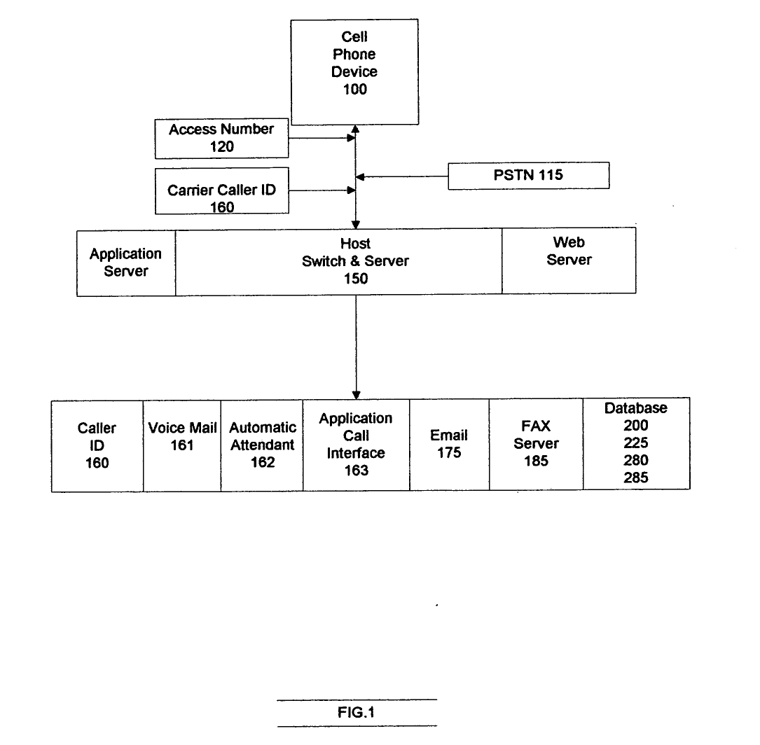

FIG. 1 is a schematic block diagram of the Host where the customer using a cell phone calls with an Access Number (120) connected by a telephone carrier with Caller ID where the call is routed to the switch and under the control of software component to the server. Many systems are capable of delivering VOIP. Cisco Systems manufactures a Tandem Switch which connects the IP network with the central office or PBX using their Voice Interworking Service Module. The preferred embodiment is a Shoretel; ShoreGear 40/8 supporting IP phones, analog ports, telephone/trunk ports. The systems endpoints using Shoretel's Media Gateway Control Protocol with 40/8 integrates signals with phone features using the Carrier Caller ID, and using Name and Number, Message. Voice Mail, Automatic Attendant, and Application Call Interface.

While the above embodiment describes a single system acting under the control of software, those skilled in the art will realize that the functionality can be distributed over a plurality of computers. The diagram in FIG. 1 identifies the Server applications supporting a customer order on a single system. The System Server (150) is typically Web server hardware and it can range from a high end PC to racks of multiprocessor, high-end computer system optimized for the task. Web server software can be Microsoft Internet Information Server, Sun Fire and Enterprise Server, IBM Websphere. The system can be distributed over a plurality of computers in a distributed architecture wherein the databases and processors are housed in separate locations. Each location is attached to a WAN which serves as a primary communication link with other locations, servers. Those skilled in the art understand, there is an unlimited number of locations, servers, that can be connected and supported. Many fulfillment locations only receive information by phone and by FAX. The present invention has the method of communicating to fulfillment location via by phone and by a FAX Server (185). The present invention uses a phone switch system and a Web server to provide the fulfillment of customer preferences. Many choices are available to customers and the present invention provides individual choice. The switch provides the use of Carrier Caller ID (160), Voice Mail (161), Automatic Attendant (162) and Application Call Interface (163). The Web server under the control of software components provides the database with through Email (175), FAX Server (185), and records and stores to database files known as the Employee File Manager (200), Customer File Manager (225), Location Database (280) and Preference Database (285).

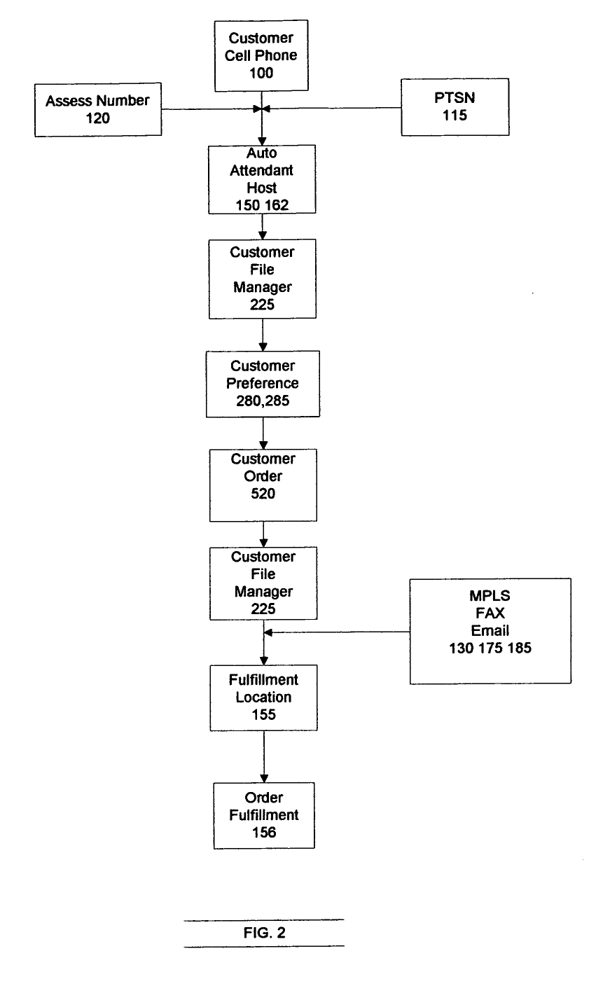

FIG. 2 is a schematic block diagram of the network where the customer uses a cell phone to connect to the Host where the system provides the access to the Preferences Database (285). The server under the control of software components identifies the caller by the Caller ID (161) and the Auto Attendant (162) sends and records (225) the customer order (520) through the network to the Fulfillment Location (155) where the customer order is fulfilled. The cell phone is connected PSTN (115) to the Host (150) and the customer is identified by his or her telephone number which is known in the art as Caller ID. Customer preferences are available wherein the customer is prompted by the system and the customer chooses the preference and orders. The order is stored in the Customer File Manager (225) and sent through the WAN/MPLS to the fulfillment location where the order is fulfilled.

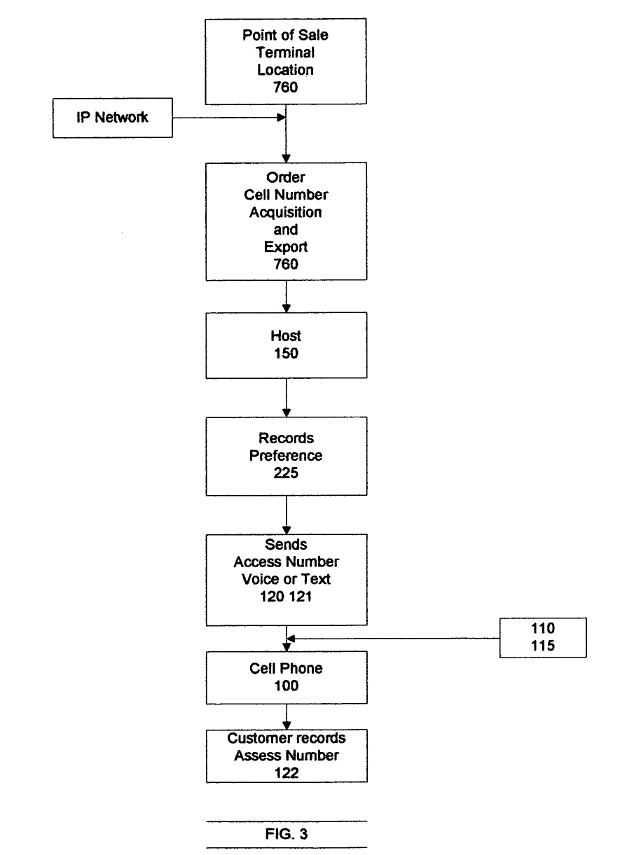

FIG. 3 is a schematic block diagram of a customer acquisition where the customer visits a fulfillment locations and orders and registers for the first time. The employee using a point of sale terminal, a Micros 3700 server (760), takes the order and inputs both the order and the customer telephone number into the terminal. The terminal under the control of software components exports the order through the IP network to the Host. The order is processed under the control of software components, and stored in the Customer File Manager (225). The present invention method of notification is sending the customer the assess number (120) from the host for future use with instruction by voice or by text (121). Other methods of notification and instructions can be sent by email, or by a written material. The preferred embodiment is the sponsored company Access Number (120) with instruction in voice or in text, Access Number Instructions (121), which is sent to the customers cell phone. Customer stores the Access Number (122).

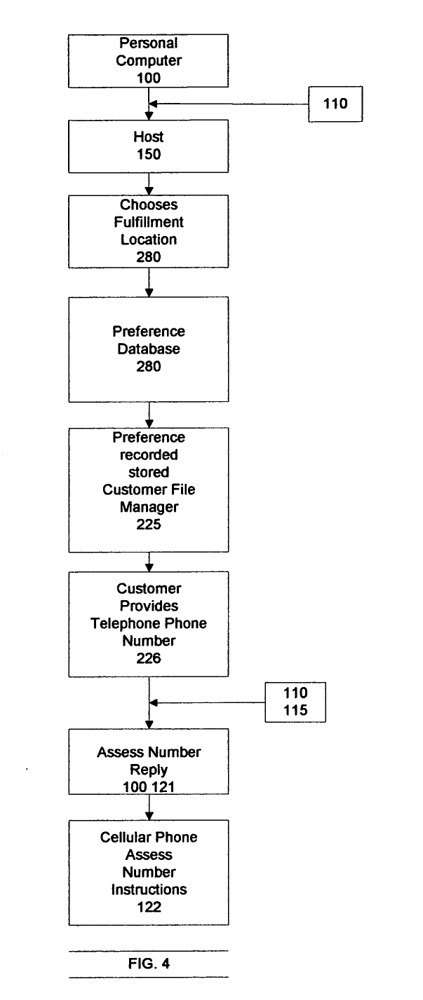

FIG. 4. is a schematic block diagram of a customer locating a fulfillment location and identifying his or her preferences. The customer using a personal computer is connected to the Host. Under the control of software components, he is directed to sponsored company locations and further directed to the product availabilities. Selecting the location preferences, and preferences, the location and preferences are recorded and stored in the Location Database (280), Preference Database (285) and Customer File Manager (225). The customer is directed further to provide his cellular phone number and to use it to order (226). The Access Number reply (120) is sent through the IP Network (110) and PTSN (115) and the customer is asked to store the Access Number Instructions (121) on his cellular phone. Customer stores Access Number (122).

It is claimed:

1. System and Method providing customers with improved service using a customer telephony device or a cellular phone connected to the customer preference database by the IP Network using the steps of:
registering the customer with a his or her telephone number with a sponsored company and calling the customer on his or her telephony device or cell phone with the access number for future use,
connecting the customer device by the network, and using voice or telephone keypad to a customer preference database,
receiving the customer order where the customer actions are made by voice or a keypad,
authorizing the order and sending the customer order from the server to the preference fulfillment location where the customer order is fulfilled.

2. The system and method of claim 1, where customer orders become preferences and said preferences are edited, new preferences are added by customers and by employees wherein employees are assigned to customers using the steps of:
using a Point of Sale terminal or network terminal to collect, to add customer preference by a customer order and enter the now preference using the said order,
recording the customer order creating a new customer file,
categoring the added preference with the customer personal name,
notifying employees of customers registration, actions, frequency of actions,

3. The method of claim 1, provides the customer notification of new locations and new products with steps of:
notifying customers by calling customers on their telephony device or cellular phone with voice, text, video or by email of new locations and of new products,
sending the new access number about new locations,
adding new access number and storing it on a telephony device,
using a device, the customer can add new locations, preferences.

4. The system of claim 3, provides the means of customer notification with the steps of:
calling the customer with the assess number where the customer having a caller ID is instructed to store the access number,
instructing the customer to label, and to name the access number on his or her telephony device or cellular phone.
